(19) United States
(12) Patent Application Publication
(10) Pub. No.: US 2004/0049483 A1
(43) Pub. Date: Mar. 11, 2004

(54) Distributed directory server

(76) Inventor: Dominique Dewilde, Palaiseau (FR)

Correspondence Address: MCCRACKEN & FRANK LLP, 200 W. ADAMS STREET, SUITE 2150, CHICAGO, IL, 60606, US

(21) Appl. No.: 10/451,979

(22) PCT Filed: Dec. 10, 2001
(86) PCT No.: PCT/FR01/03896

(30) Foreign Application Priority Data
Dec. 26, 2000 (FR) 00 17054

(51) Int. Cl. G06F 7/00

(52) U.S. Cl. 707/1

(57) ABSTRACT

The proxy server (1) provides to a local network (2) access to a distributed directory, in response to a first message containing an access request, transmitted by the local network (2), by transmitting over the local network (2) a second message containing a required reply to the request access. The proxy server comprises means (22) for transmitting a third message containing said access request to a local server (3), means (17) for receiving a fourth message from the local server (3) in response to the third message, means (18) for analysing whether the fourth message contains a required reply, means (19) for transmitting over a remote network, a fifth message containing an access request, if at least the fourth message does not contain the required reply, means (20) for receiving from the remote network, in response to the fifth message, a sixth message containing the required reply, means (21) for locally storing the required reply, received in the sixth message, means (22) for transmitting over the local network, the second message containing the required reply.

The field of the invention is that of distributed directories.

A directory is a collection of information, organized for example as a set of records, making it possible to reach an object identified in a unique manner by a name. This information comprises for example an address at which to find the object, a route indicating how to reach the object.

The following are just a few examples of known directories: telephone directories, electronic messaging directories, Internet domain directories.

In the case of a telephone directory, an object is typically a subscriber line to which one or more apparatuses (telephones, fax machines etc.) are hooked up. The name of the object (subscriber line) comprises a surname or corporate identity of the proprietor, and to alleviate any problems of homonymy a forename, location of residence (town, street, etc.). The address of the object is the telephone number.

A directory can catalogue resources of any type, such as local or remote computers, local or remote printers, terminals, etc.

The storage of this collection of information in computer databases allows appliances such as telephones, computers, to formulate queries in the form of electronic messages so as to automatically reach an identified object.

When the number of objects to be catalogued in the directory is large (worldwide telephone subscriber lines, computer servers of the Internet network, computer resources of a large enterprise), a single, centralized database has certain drawbacks. Among others may be mentioned, the latency of access to the directory itself when the appliance which formulates a query is remote from a server which hosts the single database. To this may be added problems due to a break in communication or to communication errors. Mention may also be made of the latency in retrieving a relevant item of information from a considerable volume of information, the complexity of keeping the database up to date.

In a distributed directory, the information is dispersed among various subsets of the database, each subset grouping together computer data concerning objects situated in a limited geographical or functional zone. The data of a subset, then generally reside in a server local to the zone of the objects catalogued by the directory. This allows a considerable reduction in the latency of access by an appliance to data of the directory which relate to objects situated in one and the same local zone as the appliance, both in terms of distance and volume of information to be processed.

To allow an appliance to reach any catalogued object, the distributed-directory service is rendered by systems with diverse origins which cooperate in a common language by means of standardized protocols.

For example, recommendation X.500 of the ITU (International Telecommunication Union—“The Directory: Overview and Concepts, Models and Service”, CCITT Recommendation X.500, 1988), makes provision for a hierarchical organization of the data subsets, in the form of a tree whose root designates the directory as a whole. To reach an object catalogued in the directory, an appliance, the so-called client, transmits a first message containing an access request, on a local network intended for a local server. In response, the local server transmits, intended for the client appliance, a message containing the data satisfying the access request. In the case where the data are not directly available to the local server, the latter is responsible for formulating the necessary queries intended for the remote server, by means of links to these remote servers.

A simplification of the standard is proposed in the LDAP (Lightweight Directory Access Protocol) protocol specified in the document RFC 1777 (IETF, Request For Comment 1777, “Lightweight Directory Access Protocol”, March 1995). Of LDAP type, the local server transmits a second message on the local network, intended for the client appliance. If the data relating to the said object are available in the local server, the second message contains all or part of these data so as to satisfy the access request. If the data relating to the said object are not available in the local server, the second message contains a link to a remote server. This link allows the client appliance to repeat its access request, by transmitting a new first message intended for the remote server, until the data satisfying the access request are obtained.

By applying the principle of link to another server in respect of objects whose directory data do not reside in the local server, one encounters, in respect of these objects, certain communication error and latency problems specific to centralized databases. The advantage of distributing the directory can actually be appreciated only in respect of the data stored locally.

A known solution consists in duplicating in the local server, one or more branches of the directory. The latency and link communication error problems are thus avoided. However, certain volume-related problems due to a single database are encountered. A considerable number of records which might never be used then have to be stored locally. Moreover, this solution makes it necessary for the duplicated branches of the directory to be kept up to date, in a manner consistent with their place of residence. The solution is not real-time when it is necessary to wait for an update. This solution is constraining, in particular in respect of records which are never requested.

To alleviate the drawbacks of the known prior art, the invention proposes a proxy server for affording a local network access to a distributed directory in the form of first data resident in a local server and of second data resident on a remote network, in response to a first message containing a first access request, transmitted by the local network, by transmitting on the local network a second message containing a required response to said access request.

The proxy server is noteworthy in that it comprises:

first means for transmitting a third message containing said access request intended for the local server,

second means for receiving a fourth message transmitted by the local server in reply to said third message,

third means for analyzing whether said fourth message contains a required response,

fourth means for transmitting on the remote network, a fifth message containing said first access request, if at least said fourth message does not contain said required response,

fifth means for receiving from the remote network, in response to said fifth message, a sixth message containing said required response,

sixth means for performing a local storage of said required response, received in the sixth message,

seventh means for transmitting on the local network, said second message containing said required response.

The proxy server in accordance with the invention improves the operation of prior art known servers in that it avoids the need for local storage of the data resident on a remote network which are not used, and in that it avoids the need to use a link to the remote network for data having already formed the subject of an access request.

Advantageously, the proxy server comprises means for receiving from the remote network, a message containing a notification of modification and for instructing modification of the local storage as a function of said notification.

This makes it possible to keep up to date the copies of data which are modified on a remote network without having to undertake a complete downloading of a directory branch.

For example, the fifth means are also devised so as to receive from the remote network, a seventh message containing a notification of modification of said required response and to instruct modification of the local storage as a function of said notification.

Particularly, the proxy server comprises:

eighth means for receiving from the remote network, an eighth message containing a second access request, addressed to the local server and for cataloging an origin of said eighth message,

ninth means for obtaining from the local server, a local response to said second access request and for transmitting a ninth message containing said local response, intended for said catalogued origin.

More particularly, the eighth means are devised so as to transmit a tenth message to the remote network for an origin of the eighth message whose local response is modified.

Advantageously still, the fifth means comprise a memory for containing said required response and the fourth means are devised so as to transmit the fifth message if moreover the memory does not contain said required response.

Particularly, the proxy server comprises:

tenth means for receiving said first message and for transmitting the third message containing said first access request, intended for the local server if the memory does not contain said required response.

A second object of the invention is a process for accessing a distributed directory in the form of first data resident in a local server and of second data resident on a remote network, by transmitting on a local network, a first message containing a first access request for which a required response is sent on the local network, in a second message. The process is noteworthy in that it comprises:

a first step consisting in transmitting on the remote network, a fifth message containing said first access request, if the required response is not available in any appliance of the local network,

a second step consisting in performing a local storage of said required response, received in a sixth message which contains the required response coming from the remote network and for transmitting on the local network, the second message containing said required response.

Particularly, the process for accessing a distributed directory comprises a third step consisting in modifying the local storage as a function of a remote modification notification received in a seventh message.

More particularly, the process for accessing a distributed directory comprises:

a third step consisting in cataloging an origin of an eighth message which comes from the remote network with a second access request for access to local directory data and in obtaining from the local server, a local response to said second access request,

a fourth step consisting in transmitting a ninth message containing said local response, intended for said catalogued origin.

Advantageously, said local storage is performed in a memory of a proxy server and a third message is transmitted to the local server if the memory does not contain said required response.

Numerous details and advantages of the invention are illustrated in the exemplary implementation described with reference to the figures where:

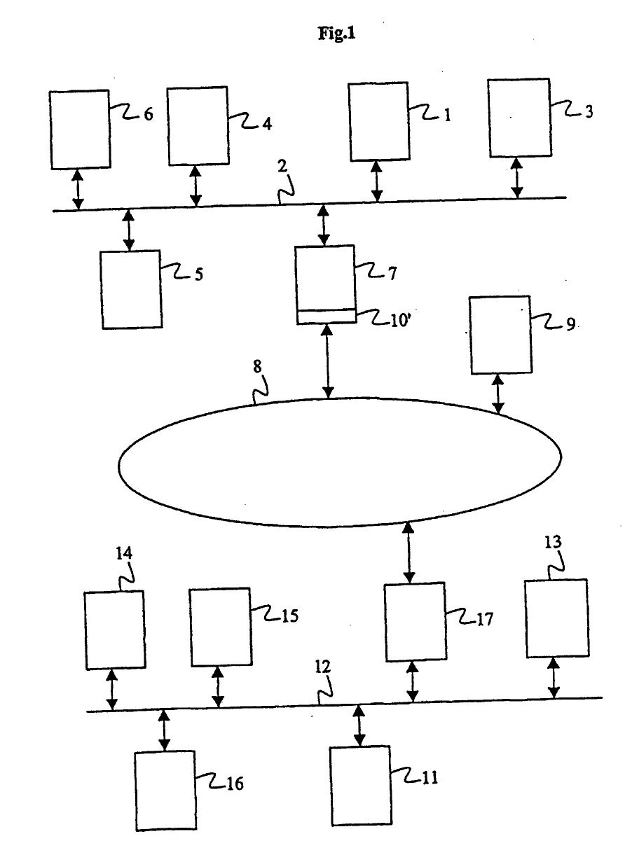

FIG. 1 represents local and remote networks for implementing the invention,

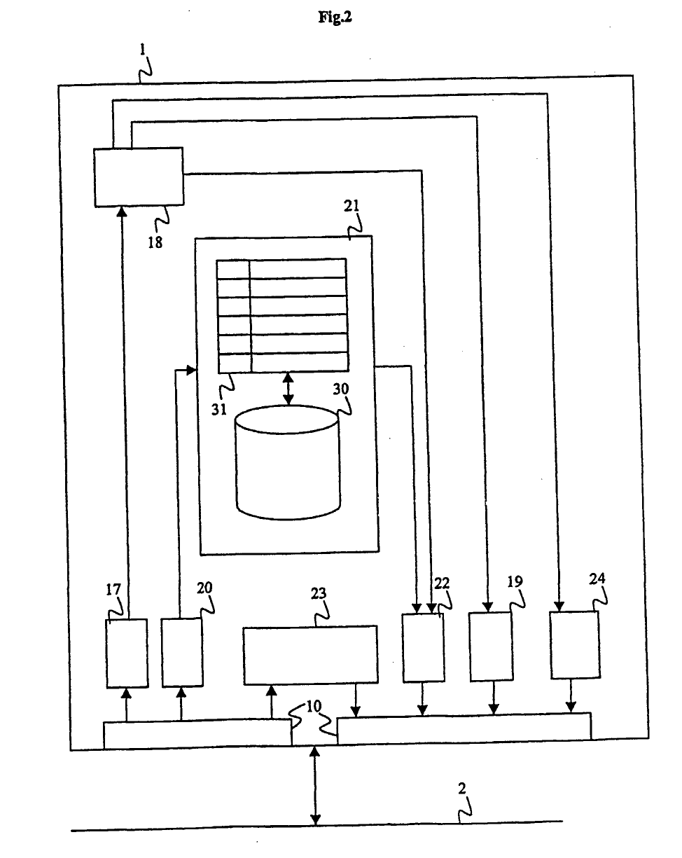

FIG. 2 illustrates a proxy server embodiment in accordance with the invention,

FIG. 3 illustrates a communication message structure,

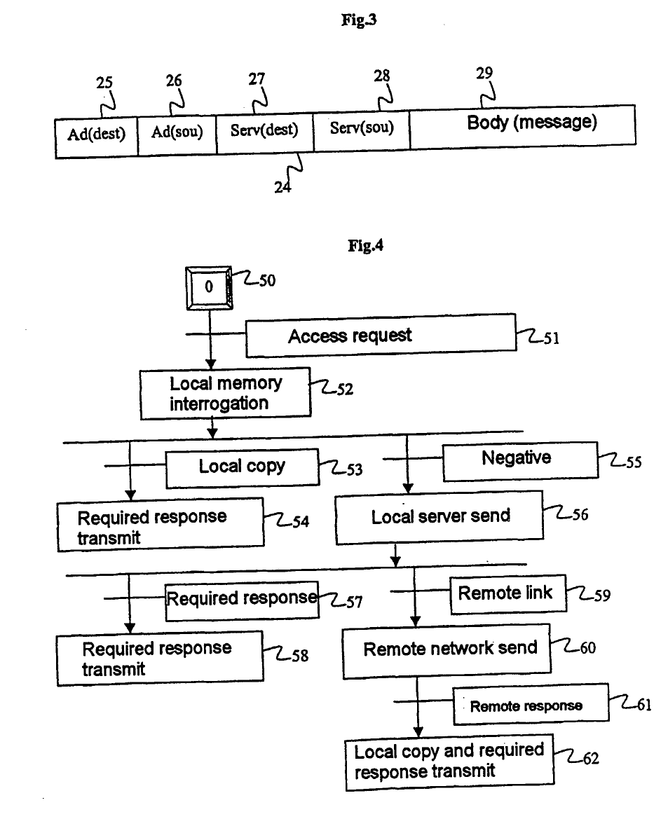

FIGS. 4 and 5 depict process steps in accordance with the invention,

FIG. 6 shows additional characteristics of a proxy server,

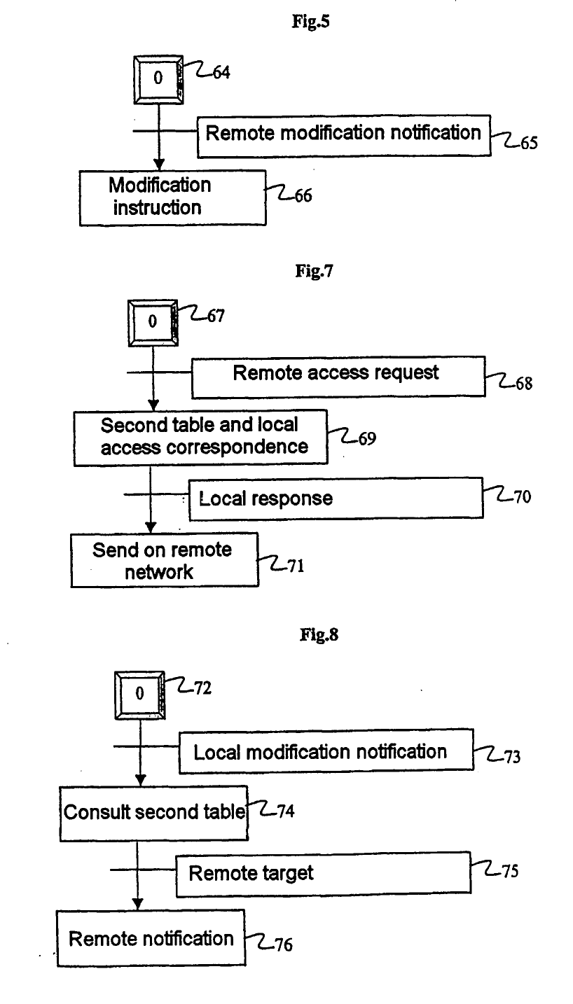

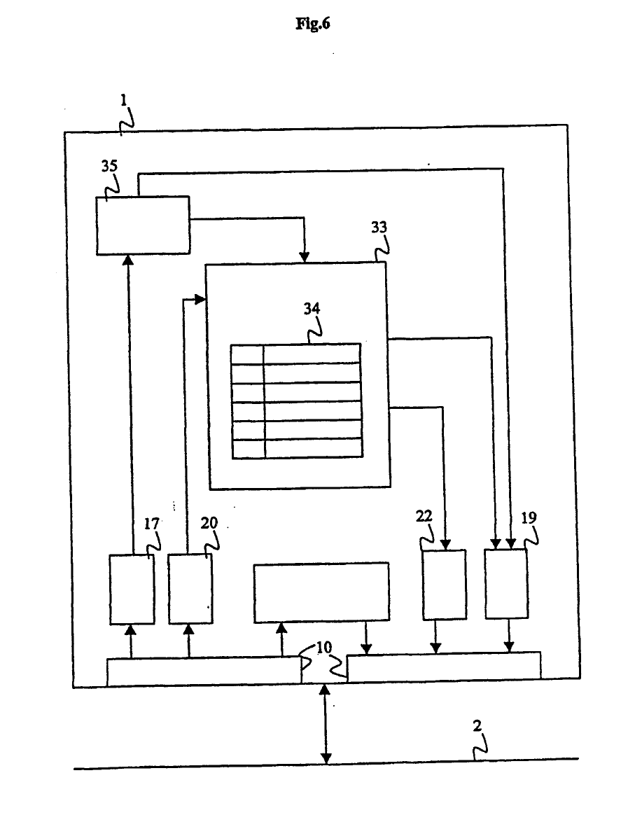

FIGS. 7 and 8 depict additional steps of the process in accordance with the invention.

With reference to FIG. 1, several client appliances are hooked up to a network 2, local to these appliances. A directory is distributed in the form of data which reside in various servers 3, 9, 13. The server 3, hooked up to the network 2, is local to the client appliances 4, 5, 6. The data of the directory which reside in the server 3 catalogue for example records which designate objects of the network 2, such as the client appliances 4, 5, 6, and the local server 3 itself.

The local network 2 is hooked up to a remote network by means of a gateway 7. The remote network comprises an extended network 8 to which one or more networks 12 are hooked up, each by means of a gateway 17. The network 12 represented here comprises client appliances 14, 15, 16 and the server 13. The data of the directory which reside in the server 13 catalogue for example records which designate objects of the network 12, such as the client appliances 14, 15, 16, the server 13, the gateway 17.

The server 9 is hooked up directly or indirectly to the extended network 8, the data of the directory which reside in the server 9 catalogue for example records which designate objects of the extended network 8, such as the networks 2, 12 and/or the server 9 itself.

Thus, the directory is distributed in the form of first data resident in the local server 3 and of second data resident on the remote network, in one of the servers 9, 13.

To access the directory, the client appliances 4, 5, 6 transmit messages on the local network 2 and, for each of the messages transmitted, wait for a message containing a required response.

A message containing an access request from the local network 2 to the directory, is addressed to a proxy server 1, which forwards it to the local server 3 when it cannot serve the request. Internal data are in fact available to the proxy server, allowing the latter to serve certain at least of the queries presented to it. In the converse case, it forwards the content of the request for access to the local server 3.

For example, if the client appliance 6 wants to reach the appliance 5, it transmits a first message containing a request for access to the directory which comprises a name of the appliance 5. When it receives this first message, the proxy server 1 consults its data so as to determine whether it can itself formulate the required response. In such a case, it builds the required response into a second message which is sent to the client appliance 6. Otherwise, it composes a third message comprising the request for access to the local network 2 which it addresses to the local server 3. The latter finds the data relating to the object constituted by the appliance 5, from among the data which reside in the local server 3 and then transmits on the network 2, intended for the proxy server 1, a fourth message containing a required response such as an address, a hardware or software configuration of the appliance 5. The content of the fourth message is forwarded by the proxy server to the client appliance 6 in a second message.

If the client appliance 6 wants to reach the appliance 15, it likewise transmits a first message containing a request for access to the directory which comprises a name of the appliance 15. The first message is transmitted on the network 2, intended for the proxy server. When it receives this first message, the proxy server 1 consults its data so as to determine whether it can itself formulate the required response. In such a case, as in the previous case it builds the required response into a second message which is sent to the client appliance 6. Otherwise, it composes a third message comprising the request for access to the local network 2 which it addresses to the local server 3. In the case where the latter, on receipt of the third message, does not find the data relating to the object constituted by the appliance 15, it then transmits on the network 2, an intermediate message containing a link to the remote network. This link directly designates the server 13 on the network 12 or the server 9 on the extended network 8 which makes it possible to establish a link to the server 13.

Depending on whether the local server 3 is of LDAP or X.500 type, the intermediate message is addressed to the proxy server 1 or, respectively, to the gateway 7 so as to be sent on the remote network intended for the server 9 or for the server 13.

In the case where the intermediate message is sent to the proxy server 1, it constitutes a fourth message containing the link to the remote network.

In the case where the intermediate message is sent on the remote network, it contains the request for access of the first message. As the case may be, the query which it transports is served by mechanisms known per se, so that the local server 3 is then able to send the proxy server 1 a fourth message which contains the required response, and which is dealt with as described above.

The proxy server 1, 11, hooked up to the local network 2, 12, is now described with reference to FIG. 2.

A network interface 10 allows the proxy server 1 to receive and to transmit messages on the network 2.

With reference to FIG. 3, each message 24 transmitted or received by a network interface such as the interface 10, comprises several fields 25, 26, 27, 28, 29. The field 25 contains a destination address. The field 26 contains a source address. The field 27 contains a destination port. The field 28 contains a source port. The field 29 contains the body of the message (or payload). For example, in the TCP/IP protocol, the destination address is the IP address of the receiver appliance, the source address is the IP address of the transmitter appliance. A client server communication model distinguishes the query messages generated by a client appliance and the response messages in reply to these queries, generated by a server appliance. In a query message, the destination port is a service number and the source port is a number allocated dynamically by the client appliance, to establish a correspondence between queries transmitted and responses received. In a response message, the destination port is the dynamically allocated number as received in the query message, and the source port is the service number. For example, an LDAP service number has decimal value 389 according to RFC 1777.

In the proxy server 1 explained with reference to FIG. 2, first means 17 are provided for receiving said first message and said fourth message. Of course, the means 17 recognize that a message received on the interface 10 is a first or a fourth message owing to the fact that the proxy server is the recipient of these messages.

Second means 18 are provided for analyzing the message received, with a view to distinguishing said first message and said fourth message.

The first message is distinguished from the fourth message by the fact that it contains a query. Its treatment is described subsequently.

The means 18 are devised to analyze the content of the body of the fourth message, which includes or otherwise a required response. A required response is recognized in the field 29 by the fact that it contains directory record attributes such as an address, an object configuration.

If the field 29 contains the required response, the body of the fourth message is sent to sixth means 22 explained subsequently. In this case, the message body is sent to the sixth means 22 so as to transmit on the local network a second message. In conjunction with the means 17 by way of the means 23, the sixth means 22 are devised to construct a second message by placing a network address of the client appliance which is the recipient of the required response in the field 25, the directory service number in the field 28 and the required response in the field 29.

When the field 29 contains no required response, the body of the fifth message contains other information such as a transmission error or a link to the remote network. In particular, the field 29 contains a link to the remote network when the local server 3 does not contain the directory data necessary for constructing the required response. In this case, the message body is sent to third means 19 so as to transmit on the remote network, a fifth message. The third means 19 are devised so as to extract from the link information, a destination address on the remote network and a request for access to the directory. The third means 19 are also devised so as to construct the fifth message by placing in the field 25, the extracted destination address, in the field 26, the network address of the proxy server 1, in the field 27, the directory service number concerned, in the field 28, a dynamically allocated port number and in the field 29 the request for access to the directory. The fifth message is then transmitted by the means 19 in cooperation with the interface 10, on the local network 2, intended for the remote network.

A gateway 7 of known type, makes it possible to pass the messages from the local network 2 to the remote network. The proxy server can reside in a separate machine as represented in FIG. 1. The proxy server can also reside in the gateway 7, in which case the third means 19 are linked to an interface 10′ of the gateway 7, so as to transmit the fifth message on the extended network 8.

Fourth means 20 are hooked up to the interface 10 in the case where the proxy server resides in a separate machine from the gateway 7. The fourth means 20 are hooked up to the interface 10′ in the case where the proxy server resides in the gateway 7.

The means 23 are devised so as to manage the message exchange contexts, in conjunction with the means 17, 20, 22 and 19, so as to allow the latter the matching of the messages received with the messages dispatched.

The fourth means 20 are devised so as to receive a sixth message received from the remote network in response to the fifth message. In conjunction with the means 19 by way of the means 23, the means 20 recognize that the sixth message is received in response to the fifth message by the contents of the fields 27 and 28 of the sixth message, which are equal respectively to the contents of the fields 28 and 27 of the fifth message.

The means 20 are linked to fifth means 21 so as to transfer to them a required response contained in the field 29 of the sixth message. The means 21 are devised so as to perform a local storage of the required response. The means 21 are linked to the means 22 so as to transmit to them the required response as stored locally.

According to a preferred embodiment of the invention as explained with reference to FIG. 2, the means 21 comprise a memory 30 for containing each required response contained in the field 29 of a sixth message. The means 21 are then linked to the means 18, so that the means 19 transmit a fifth message only if the memory 30 does not contain the required response.

Thus, in the case where the memory 30 does not contain the required response, the parameters of the first message detected are then sent to transmission means 24, which cooperate with means 23 described subsequently. The means 24 are devised so as to construct a third message which contains a network address of the local server in the field 25, a network address of the proxy server 1 in the field 26, the directory service number in the field 27, a dynamic port number in the field 28, the access request in the field 29. The means 24 are linked to the interface 10 so as to transmit the third message thus constructed on the local network intended for the local server 3.

In the case where the memory 30 contains the required response, the parameters of the first message detected are then sent to the sixth means 22 which are implemented as explained previously.

It will be noted that the proxy server 1 could also reside in the same computer machine as the local server 3. In this case, the means 17, 23 and 32 communicate directly with the local server 3 inside the machine which hosts them.

With reference to FIG. 2, the means 21 comprise a first table 31 in which is referenced each required response which relates to directory data resident on the remote network and which is stored locally. The table 31 makes it possible to indicate a validity value for each stored response.

The fourth means 20 are devised so as to receive from the remote network, a seventh message containing in its field 29, a notification of modification of directory data. Means 20 then send the body of the seventh message to the means 21 which then invalidate the stored responses, corresponding to the notification of modification. The means 21 are devised so as to implement at least one of the following two strategies.

According to a first strategy, after a short pause the means 22 transmit an access request on the remote network in respect of the objects for which the storage of the directory data is invalidated by the notification received.

This makes it possible for the locally stored directory data to be kept up to date and to respond rapidly to any new subsequent access request relating to these data.

According to a second strategy, the storage of the directory data is simply invalidated. At the next access request transmitted by a client appliance on the local network, the absence of a valid copy of the required response prompts transmission of a fifth message. The updating of the local storage is performed following receipt of a sixth message.

A process for improving access to a distributed directory is now explained with reference to FIG. 4.

In an initial step 50, the proxy server 1 is placed on standby awaiting the messages flowing around the local bus 2 which are addressed to it with a directory service number in their field 27.

Each receipt of a first message with a request for access to the distributed directory in its field 29 validates a transition 51 which activates a step 52.

In step 52, the proxy server 1 interrogates the local memory 21 so as to extract therefrom a required response to the access request.

If the memory 21 contains a local copy of the required response, a transition 53 is validated.

Otherwise, a transition 55 is validated.

The transition 53 activates a step 54 in which the proxy server constructs the second message with the required response in its field 29. The proxy server 1 then uses the means 22 to transmit the second message on the local network 2.

The transition 55 activates a step 56 in which the proxy server 1 forwards the content of the first message in the third message to the local server 3, using for example the means 22, in conjunction with the means 23. If the access request relates to an object in respect of which the directory data reside in the local server 3, the local server 3 transmits a fourth message on the network 2, with in the field 29 of the fourth message, the required response. If the access request relates to an object in respect of which the directory data do not reside in the local server 3, the local server 3 transmits an intermediate message on the network 2, with in the field 29 of the intermediate message, a link to the remote network which makes it possible to access the directory data which reside on the remote network.

The proxy server 1 uses the means 17 to receive the fourth message and the means 18 to analyze the content of the field 29 of the fourth message.

A required response in the field 29 of the fourth message validates a transition 57. A link in the field 29 of the fourth message validates a transition 59.

The transition 57 activates a step 58 in which the proxy server 1 uses the means 22 to transmit a second message on the network 2 with the required response in its field 29.

The transition 59 activates a step 60 in which the proxy server 1 uses the means 19, in conjunction with the means 23, to transmit a fifth message to the remote network, containing the access request in its field 29.

The remote network generates a sixth message containing in its field 29 a required response to the access request.

The proxy server 1 uses the means 20, in conjunction with the means 23, to receive the sixth message which validates a transition 61.

The transition 61 activates a step 62 in which the proxy server stores the required response in the memory 21 and constructs a second message with the required response in its field 29. The proxy server 1 then uses the means 22, in conjunction with the means 23, to transmit the second message on the network 2.

FIG. 5 shows the execution of a second procedure. In an initial step 64, the proxy server 1 uses the fourth means 20 to listen out for receipt of a seventh message containing in its field 29 a remote modification notification.

The receipt of the seventh message validates a transition 65 which activates a step 66. In step 66, the proxy server 1 instructs modification of the local storage as a function of the notification.

With reference to FIG. 6, the proxy server 1 advantageously comprises seventh means 33 for receiving a request for access to the directory local data. This second access request stems from the field 29 of an eighth message received by the means 20, originator of the remote network. The means 33 comprise a second table 34 for cataloguing the origin of the ninth message, as contained in the field 26, in correspondence with a directory object name as contained in the access request. The means 33 are linked to the means 22 so as to forward the eighth message to the local server 3, for which the eighth message is intended.

Eighth means 35 are linked to the means 17 to obtain from the local server 3, a local response to the second access request. The means 35 are linked to the means 19 to transmit a ninth message containing the local response, intended for the appliance from which the access request originated.

The means 35 are linked to the means 33 so as to consult the second table 34 when a notification of modification of local data of directories is received on the means 17, so as to dispatch a notification of modification intended for the appliances of the remote network which are catalogued in the second table 34 as having made a request for access to the directory data concerned in the notification of modification. The notification of modification is then encapsulated in a ninth message transmitted by the means 19.

FIG. 7 depicts a third procedure advantageously executed by the proxy server 1, using the means described previously with reference to FIG. 6. In an initial step 67, the proxy server 1 is made to listen out for an eighth message by the means 20. A remote access request in the field 29 of the eighth message validates a transition 68 which activates a step 69.

In step 69, the proxy server 1 catalogues the remote access request in the second table 34 by establishing a correspondence between the object of the access request and the origin of the access request. The proxy server 1 sends the access request to the local server 3.

Receipt of a local response by the means 17 validates a transition 70 which activates a step 71.

In step 71, the proxy server 1 sends the response on the remote network.

FIG. 8 depicts a fourth procedure advantageously executed by the proxy server 1 using the means described previously with reference to FIG. 6. In an initial step 72, the proxy server 1 is placed on standby awaiting a tenth message by the means 17. A local modification notification in the field 29 of the tenth message validates a transition 73 which activates a step 74.

In step 74, the proxy server 1 consults the second table 34 so as to retrieve a correspondence between the object of the notification of modification and the origin or origins of remote access requests in respect of this object.

Each origin retrieved identifies a remote target which validates a transition 75. The transition 75 activates a step 76 in which the proxy server 1 dispatches the tenth message containing the notification of modification on the remote network, intended for the targeted appliances.

1. A proxy server (1) for affording a local network (2) access to a distributed directory in the form of first data resident in a local server (3) and of second data resident on a remote network, in response to a first message containing a first access request, transmitted by the local network (2), by transmitting on the local network (2) a second message containing a required response to said access request, proxy server characterized in that it comprises:
first means (22) for transmitting a third message containing said access request intended for the local server (3),
second means (17) for receiving a fourth message transmitted by the local server (3) in reply to said third message,
third means (18) for analyzing whether said fourth message contains a required response,
fourth means (19) for transmitting on the remote network, a fifth message containing said first access request, if at least said fourth message does not contain said required response,
fifth means (20) for receiving from the remote network, in response to said fifth message, a sixth message containing said required response,
sixth means (21) for performing a local storage of said required response, received in the sixth message,
seventh means (22) for transmitting on the local network, said second message containing said required response.

2. The proxy server as claimed in claim 1, characterized in that the fifth means are also devised so as to receive from the remote network, a seventh message containing a notification of modification of said required response and to instruct modification of the local storage as a function of said notification.

3. The proxy server as claimed in claim 2, characterized in that it comprises:
eighth means (33) for receiving from the remote network, an eighth message containing a second access request, addressed to the local server (3) and for cataloging an origin of said eighth message,
ninth means for obtaining from the local server, a local response to said second access request and for transmitting a ninth message containing said local response, intended for said catalogued origin.

4. The proxy server as claimed in claim 3, characterized in that the eighth means are devised so as to transmit a tenth message to the remote network for an origin of the eighth message whose local response is modified.

5. The proxy server as claimed in one of claims 1 to 3, characterized in that the fifth means (21) comprise a memory (24) for containing said required response and in that the fourth means are devised so as to transmit the fifth message if moreover the memory (24) does not contain said required response.

6. The proxy server as claimed in one of the preceding claims, characterized in that it comprises:
tenth means (23) for receiving said first message and for transmitting the third message containing said first access request, intended for the local server if the memory (24) does not contain said required response.

7. A process for accessing a distributed directory in the form of first data resident in a local server (3) and of second data resident on a remote network, by transmitting on a local network (2), a first message containing a first access request for which a required response is sent on the local network (2), in a second message, the process characterized in that it comprises:
a first step (60) consisting in transmitting on the remote network, a fifth message containing said first access request, if the required response is not available in any appliance of the local network (2),
a second step (62) consisting in performing a local storage of said required response, received in a sixth message which contains the required response coming from the remote network and for transmitting on the local network (2), the second message containing said required response.

8. A process for accessing a distributed directory as claimed in claim 7, characterized in that it comprises a third step (66) consisting in modifying the local storage as a function of a remote modification notification received in a seventh message.

9. The process for accessing a distributed directory as claimed in claim 8, characterized in that it comprises:
a third step (69) consisting in cataloging an origin of an eighth message which comes from the remote network with a second access request for access to local directory data and in obtaining from the local server, a local response to said second access request,
a fourth step (71) consisting in transmitting a ninth message containing said local response, intended for said catalogued origin.

10. A process for accessing a distributed directory as claimed in one of claims 7 to 9, characterized in that said local storage is performed in a memory (24) of a proxy server and in that a third message is transmitted to the local server (3) if the memory (24) does not contain said required response.
